(19) United States
(12) Patent Application Publication
(10) Pub. No.: US 2002/0146671 A1
(43) Pub. Date: Oct. 10, 2002

(54) Instructional device for bowling

(76) Inventor: Anthony J. Norcia JR., Point Pleasant, NJ (US)

Correspondence Address: Richard W. Goldstein, 2071 Clove Road, Staten Island, NY, 10304, US

(21) Appl. No.: 09/829,283

(22) Filed: Apr. 9, 2001

(51) Int. Cl. G09B 9/00; G09B 19/00; A63B 69/00

(52) U.S. Cl. 434/249

(57) ABSTRACT

An instructional device for bowling including a board portion having a generally rectangular configuration defined by opposed short upper and lower edges and opposed long side edges. The board portion has an upper surface and a lower surface. The upper surface has indicia thereon to replicate a standard bowling lane. The upper surface is a scale model of a standard bowling lane. The indicia include longitudinal board lines, a pin deck, lo alignment arrows, targeting dots, a foul line, and approach dots. An acetate overlay is disposed over the upper surface of the board portion. The acetate overlay allows a use of dry erase pens on the board portion for instructional purposes.

### BACKGROUND OF THE INVENTION

The present invention relates to an instructional device for bowling and more particularly pertains to allowing a teacher to properly teach proper bowling techniques and strategy.

The use of sport teaching aids is known in the prior art. More specifically, sport teaching aids heretofore devised and utilized for the purpose of facilitating the teaching of sports are known to consist basically of familiar, expected and obvious structural configurations, notwithstanding the myriad of designs encompassed by the crowded prior art which have been developed for the fulfillment of countless objectives and requirements.

By way of example, U.S. Pat. No. 4,776,801 to Summers discloses a bowler's assisting device comprised of a base with a transparent overlay. U.S. Pat. No. 4,773,644 to Lashman discloses a bowler's approach guide comprised of a thin, flat sheet device sized to correspond to the approach area for a bowling area. U.S. Pat. No. 4,937,772 to Chavez discloses a portable computer device for aiding bowlers.

While these devices fulfill their respective, particular objective and requirements, the aforementioned patents do not describe an instructional device for bowling for allowing a teacher to properly teach proper bowling techniques and strategy.

In this respect, the instructional device for bowling according to the present invention substantially departs from the conventional concepts and designs of the prior art, and in doing so provides an apparatus primarily developed for the purpose of allowing a teacher to properly teach proper bowling techniques and strategy.

Therefore, it can be appreciated that there exists a continuing need for a new and improved instructional device for bowling which can be used for allowing a teacher to properly teach proper bowling techniques and strategy. In this regard, the present invention substantially fulfills this need.

### SUMMARY OF THE INVENTION

In the view of the foregoing disadvantages inherent in the known types of sport teaching aids now present in the prior art, the present invention provides an improved instructional device for bowling. As such, the general purpose of the present invention, which will be described subsequently in greater detail, is to provide a new and improved instructional device for bowling which has all the advantages of the prior art and none of the disadvantages.

To attain this, the present invention essentially comprises a board portion having a generally rectangular configuration defined by opposed short upper and lower edges and opposed long side edges. The board portion has an upper surface and a lower surface. The upper surface has indicia thereon to replicate a standard bowling lane. The upper surface is a scale model of a standard bowling lane. The indicia include longitudinal board lines, a pin deck, alignment arrows, targeting dots, a foul line, and approach dots. An acetate overlay is disposed over the upper surface of the board portion. The acetate overlay allows a use of dry erase pens on the board portion for instructional purposes.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved instructional device for bowling which has all the advantages of the prior art sport teaching aids and none of the disadvantages.

It is another object of the present invention to provide a new and improved instructional device for bowling which may be easily and efficiently manufactured and marketed.

It is a further object of the present invention to provide a new and improved instructional device for bowling which is of durable and reliable construction.

An even further object of the present invention is to provide a new and improved instructional device for bowling which is susceptible of a low cost of manufacture with regard to both materials and labor, and which accordingly is then susceptible of low prices of sale to the consuming public, thereby making such an instructional device for bowling economically available to the buying public.

Even still another object of the present invention is to provide a new and improved instructional device for bowling for allowing a teacher to properly teach proper bowling techniques and strategy.

Lastly, it is an object of the present invention to provide a new and improved instructional device for bowling including a board portion having a generally rectangular configuration defined by opposed short upper and lower edges and opposed long side edges. The board portion has an upper surface and a lower surface. The upper surface has indicia thereon to replicate a standard bowling lane. The upper surface is a scale model of a standard bowling lane. The indicia include longitudinal board lines, a pin deck, alignment arrows, targeting dots, a foul line, and approach dots. An acetate overlay is disposed over the upper surface of the board portion. The acetate overlay allows a use of dry erase pens on the board portion for instructional purposes.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a plan view of the preferred embodiment of the instructional device for bowling constructed in accordance with the principles of the present invention.

FIG. 2 is a front view of the present invention.

The same reference numerals refer to the same parts through the various figures.

### DESCRIPTION OF THE PREFERRED EMBODIMENT

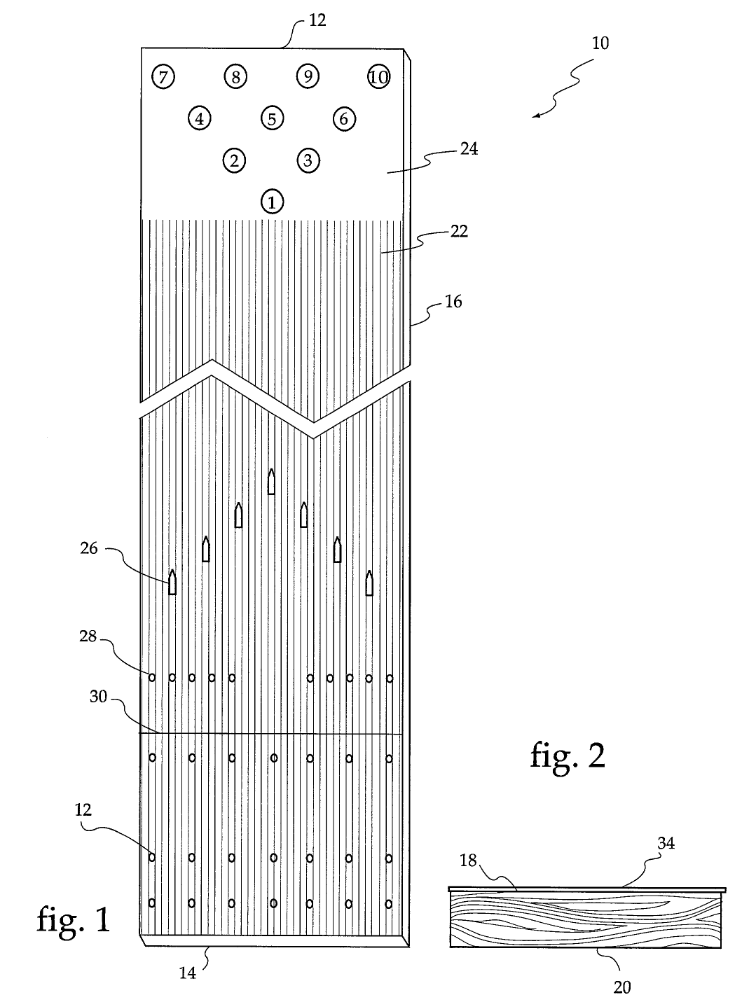

With reference now to the drawings, and in particular, to FIGS. 1 and two thereof, the preferred embodiment of the new and improved instructional device for bowling embodying the principles and concepts of the present invention and generally designated by the reference number 10 will be described.

Specifically, it will be noted in the various Figures that the device relates to an instructional device for bowling for allowing a teacher to properly teach proper bowling techniques and strategy. In its broadest context, the device consists of a board portion and an acetate overlay. Such components are individually configured and correlated with respect to each other so as to attain the desired objective.

The board portion 10 has a generally rectangular configuration defined by opposed short upper and lower edges 12,14 and opposed long side edges 16. The board portion 10 has an upper surface 18 and a lower surface 20. The upper surface 18 has indicia thereon to replicate a standard bowling lane. The upper surface 18 is a scale model of a standard bowling lane. The indicia include longitudinal board lines 22, a pin deck 24, alignment arrows' 26, targeting dots 28, a foul line 30, and approach dots 32. The board portion 10 can be positioned in an upright orientation to allow the upper surface 18 to be displayed in front of an audience for easy viewing.

The acetate overlay 34 is disposed over the upper surface 18 of the board portion 10. The acetate overlay 34 allows a use of dry erase pens on the board portion 10 for instructional purposes. The use of the dry erase pens will allow an instructor to write directly on the present invention to illustrate bowling strategy and techniques which can later be erased for the next lesson.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modification and equivalents may be resorted to, falling within the scope of the invention.

What is claimed as being new and desired to be protected by Letters Patent of the United States is as follows:

1. An instructional device for bowling for allowing a teacher to properly teach proper bowling techniques and strategy comprising, in combination:
a board portion having a generally rectangular configuration defined by opposed short upper and lower edges and opposed long side edges, the board portion having an upper surface and a lower surface, the upper surface having indicia thereon to replicate a standard bowling lane, the upper surface being a scale model of a standard bowling lane, the indicia including longitudinal board lines, a pin deck, alignment arrows, targeting dots, a foul line, and approach dots; and
an acetate overlay disposed over the upper surface of the board portion, the acetate overlay allowing a use of dry erase pens on the board portion for instructional purposes.
